(19) United States
(12) Patent Application Publication
(10) Pub. No.: US 2014/0176047 A1
(43) Pub. Date: Jun. 26, 2014

(54) HANDHELD TOOL BATTERY DEVICE

(71) Applicants: Marcin REJMAN, Waiblingen (DE); Guenter LOHR, Leinfelden-Echterdingen (DE); Juergen MACK, Goeppingen (DE); Dragan KRUPEZEVIC, Stuttgart (DE)

(72) Inventors: Marcin REJMAN, Waiblingen (DE); Guenter LOHR, Leinfelden-Echterdingen (DE); Juergen MACK, Goeppingen (DE); Dragan KRUPEZEVIC, Stuttgart (DE)

(73) Assignee: ROBERT BOSCH GMBH, Stuttgart (DE)

(21) Appl. No.: 14/134,730

(22) Filed: Dec. 19, 2013

(30) Foreign Application Priority Data
Dec. 21, 2012 (DE) 10 2012 112 881.2

(51) Int. Cl. H02J 7/02

(52) U.S. Cl. CPC H02J 7/025
USPC 320/106

(57) ABSTRACT

A handheld tool battery device includes: a communication unit; at least one cell unit for storing energy; and at least one induction charging unit for charging and/or discharging the at least one cell unit. The communication unit transmits design-specific parameters to a charging device during a charging process.

### BACKGROUND OF THE INVENTION

1. Field of the Invention

The present invention relates to a handheld tool battery device.

2. Description of the Related Art

A handheld tool battery device has been proposed in the past, having a communication unit, having at least one cell unit for storing energy, and having at least one induction charging unit for charging and/or discharging the at least one cell unit.

### BRIEF SUMMARY OF THE INVENTION

The present invention provides a handheld tool battery device having a communication unit, at least one cell unit for storing energy, and at least one induction charging unit for charging and/or discharging the at least one cell unit.

It is proposed that the communication unit be provided to transmit design-specific parameters to a charging device during a charging process. By “handheld tool battery device” one should particularly understand in this connection a battery device for a handheld machine tool. A “battery device” is to be understood in this context in particular as a device for the temporary storage of electrical energy, in particular an accumulator. Preferably, this is to be understood in particular as a rechargeable storage device. Various battery devices that seem useful to one skilled in the art are conceivable, but in the present case the battery device is to be understood in particular as a lithium-ion accumulator. A “handheld machine tool” in this instance is to be understood in particular as a workpiece-machining machine tool, advantageously a drilling machine, a drilling and/or percussion hammer, a saw, a plane, a screwdriver, a milling tool, a grinder, an angle grinder, a gardening device and/or a multifunctional tool. Furthermore, “communication unit” should particularly be understood in this connection as a unit provided for the exchange of data signals and/or control signal. By this one should preferably understand a unit that is at least provided to transmit data signals and/or control signals actively and/or passively, particularly to a receiving unit. In this context, a transmission may take place in an analog and especially a digital manner. Moreover, a transmission may take place in a wireless manner as well as wire-bound. Various wireless transmitting techniques are conceivable, that appear useful to one skilled in the art, such as via Bluetooth, WLAN, UMTS, NFC or via an optical interface. Moreover, various wire-bound transmitting techniques are conceivable, that appear useful to one skilled in the art. It should particularly be understand in this connection by “active and/or passive” that data signals and/or control signals are able to be transmitted completely actively, completely passively, partially actively or varyingly actively, passively or partially actively. In this context, “passively” should particularly be understood to mean that the data are selected for transmission by the charging device. Furthermore, one should understand in this connection by “partially active” that the data signals and/or control signals are transmitted only partially actively. By a cell unit one should understand in this connection, particularly a part of an accumulator device which is provided directly to store electrical energy temporarily. Preferably one should thereby particularly understand a unit that is provided to store electrical energy temporarily on an electrochemical basis. Particularly preferably this is to be understood as a rechargeable unit. The cell unit particularly preferably is made up of one or more cell elements that are especially connected to one another electrically. Various cell elements that seem useful to one skilled in the art are conceivable, but in particular, one should understand a lithium-ion cell. An “induction charging unit”, in this connection, is to be understood in particular as a unit that is provided to convert electrical energy to a magnetic field or especially a magnetic field to electrical energy. Preferably, this is to be understood as a part of an induction charging device that is provided to transmit energy, in particular at least partially contactlessly, by induction from a charging device to a battery device. The charging device preferably has an induction charging unit, which is provided to convert electrical energy to a magnetic field, which is able to be converted back to electrical energy again by the induction charging unit The induction charging unit particularly preferably has at least one charging coil. A “charging coil” in this context is to be understood in particular as an element that is made up, at least partially, of an electrical conductor, in particular a wound electrical conductor, which is disposed at least partially in the form of a circular disk. Preferably, a voltage is induced in the electrical conductor when a magnetic field is applied. Furthermore, in this connection, a “charging operation” is to be understood in particular as a process in which the cell unit of the handheld tool battery device is supplied with energy externally. Preferably, one should understand by this in particular a process, in which the cell unit of the handheld tool battery device temporarily stores the energy supplied externally. By “design-specific parameters” one should understand in this connection particularly parameters which are in each case assigned to at least one property and/or at least one state of the handheld tool battery device, and which describe these at least partially. Preferably one should understand in this connection particularly parameters which are in each case assigned to at least one permanent property and/or at least one long-term state and which describe these at least partially. A “charging device” is to be understood in this context in particular as a device for charging battery devices, in particular accumulators. The device preferably has at least one control and/or regulating unit, which is provided to control and/or regulate a charging process.

Because of the embodiment of the handheld tool battery device according to the present invention, it may advantageously be achieved that the design-specific parameters of the handheld tool battery device are able to be transmitted to a charging device. Thereby it may advantageously be achieved that, in a charging device, design-specific parameters are able to be taken into account in a charging process.

It is further proposed that the communication unit be provided to transmit a battery quality factor to the charging device during a charging process. By a “battery quality factor” one should understand, in this connection, particularly a design-specific parameter of the handheld tool battery device which at least partially describes a condition and/or a quality and/or a system property of the handheld tool battery device. Various battery quality factors, that appear sensible to one skilled in the art, are conceivable, such as a parameter of a charging quality of the handheld tool battery device and/or a parameter of a resonant circuit quality of the handheld tool battery device and/or a parameter of the state of wear of the handheld tool battery device. In this context, by “charging quality” one should understand in this connection particularly a current state and/or a current quality of a charging process of the battery device by the charging device. Preferably one should understand by this particularly a current quality and/or a current efficiency of a charging process of the battery device by the charging device. Particularly preferred, one should understand by this an efficiency of an energy transmission by the charging device to the battery device. Because of this, in particular, a charging process is able to be adjusted to at least one battery quality factor of the handheld tool battery device. Furthermore, it would be conceivable that thereby battery quality factors are able to be output by the charging device to an operator.

It is further provided that the handheld tool battery device have a memory unit, which is provided for the nonvolatile storage of the design-specific parameters. By a “memory unit” one should understand in this connection especially a unit that is provided to store at least one information that is independent of the power supply. The memory unit is preferably designed as a nonvolatile data memory for nonvolatile storage. In this context, by a “nonvolatile data memory” one should understand in this connection particularly a memory unit which is able to store information and/or other data permanently, independently of a power supply and particularly free of data losses. Various nonvolatile data memories, that appear useful to one skilled in the art, are conceivable, such as magnetic storage media, digital memory chips or optical memories. By using these, design-specific parameters are able to be filed, particularly permanently, on the handheld tool battery device. Moreover, an advantageous retrieval of the design-specific parameters is able to take place. In addition, the design-specific parameters do not have to be ascertained time and again.

It is further provided that the communication unit be provided to transmit to the charging device, in addition, at least one characteristics variable of a maximum current of the cell unit, during a charging process. By a “characteristics variable of a maximum current” one should understand in this connection particularly a characteristics variable which describes and/or represents at least partially a maximum admissible charging current and/or another maximum current. Thereby a characteristics variable of a maximum current may advantageously be transmitted to the charging device and particularly taken into account by the charging device. Furthermore, the communication unit for transmitting various characteristics variables and parameters may thereby be used, whereby in particular, the number of parts in the handheld tool battery device may be held low.

It is further provided that the communication unit be provided to transmit to the charging device, in addition, at least one characteristics variable of a temperature of the cell unit, during a charging process. By a “characteristics variable of a temperature” one should understand in this connection particularly a characteristics variable which at least partially describes or represents a current temperature of the cell unit. Thereby a characteristics variable of a temperature may advantageously be transmitted to the charging device and particularly be taken into account by the charging device, especially so as to avoid overheating. Furthermore, the communication unit for transmitting various characteristics variables and parameters may thereby be used, whereby in particular, the number of parts in the handheld tool battery device may be held low.

It is further provided that the communication unit be provided to transmit to the charging device, in addition, at least one characteristics variable of a voltage of the cell unit, during a charging process. By a “characteristics variable of a voltage” one should understand in this connection particularly a characteristics variable which at least partially describes or represents a current temperature of the cell unit. Thereby a characteristics variable of a voltage may advantageously be transmitted to the charging device and particularly taken into account by the charging device. Furthermore, the communication unit for transmitting various characteristics variables and parameters may thereby be used, whereby in particular, the number of parts in the handheld tool battery device may held low.

Moreover, it is provided that the handheld tool battery device have at least one registration unit for registering at least one characteristics variable of a maximum current and/or a temperature and/or a voltage of the cell unit having at least one sensor unit. By a “registration unit” one should understand in this connection particularly a unit having at least one sensor unit. Preferably one should understand thereby particularly a unit that is provided for registering at least one characteristics variable, particularly preferably of a maximum current and/or of a temperature and/or of a voltage. Various registration units are conceivable, that appear useful to one skilled in the art. By a “sensor unit” one should understand in this connection particularly a unit that is provided to register at least one characteristics variable and/or a physical property, a registration being able to take place actively, such as especially by generating and emitting an electrical measuring signal, and/or passively, such as particularly by registering property changes of a sensor component and/or by registering a current and/or a voltage flowing through a resistor. Thereby current characteristics variables of the handheld tool battery device may advantageously be registered.

The handheld tool storage device according to the present invention should not, in this case, be restricted to the application and the execution described above. In order to fulfill a method of functioning described herein, the handheld tool battery device according to the present invention may in particular have a number of individual elements, components and units that deviates from a number mentioned herein.

### BRIEF DESCRIPTION OF THE DRAWINGS

FIG. 1 shows an handheld tool battery device having an induction charging unit and a charging device according to the present invention in a charging operation, in a schematic representation.

FIG. 2 shows a partial section of the handheld tool battery device and the charging device according to the present invention in a charging operation, in a schematic sectional representation.

FIG. 3 shows a simplified circuit diagram of the handheld tool battery device according to the present invention and the charging device according to the present invention in a charging operation.

### DETAILED DESCRIPTION OF THE INVENTION

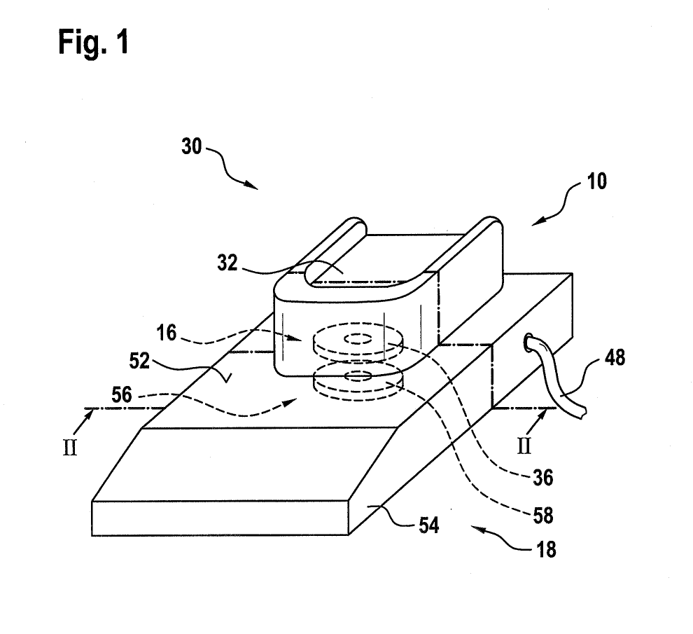

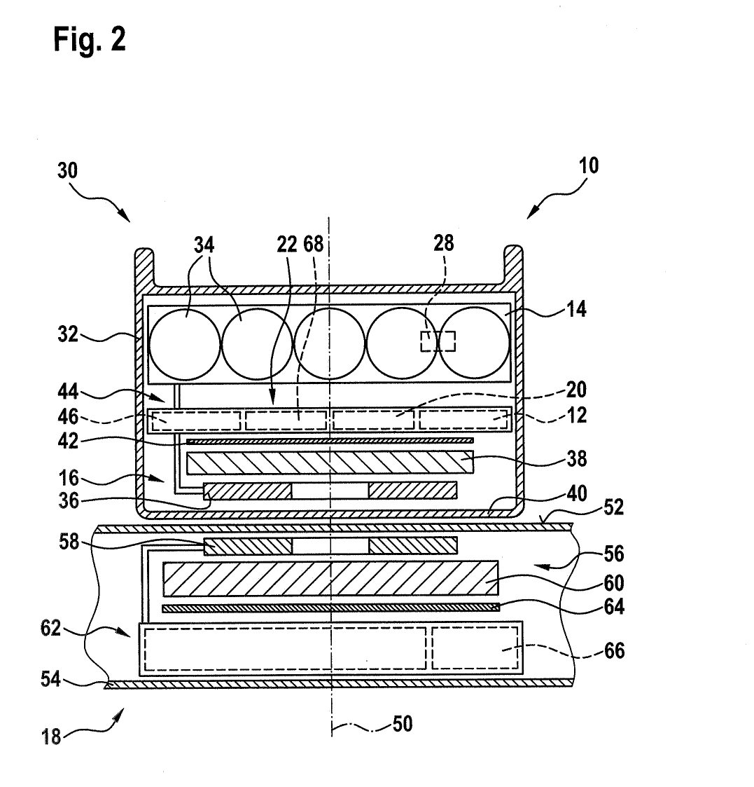

FIG. 1 shows a handheld tool battery device 10 according to the present invention and a charging device 18 according to the present invention. Handheld tool battery device 10 has a housing unit 32 and a cell unit 14 for storing energy. Furthermore, cell unit 14 is provided to supply a handheld machine tool, that is not further visible, with energy. Cell unit 14 is situated in housing unit 32. Cell unit 14 has five cell elements 34, which are each formed by lithium-ion cells (FIG. 2). Cell elements 34 are connected electrically conductively to one another in a series connection. Moreover, handheld tool battery device 10 has an induction charging unit 16 for charging cell unit 14. Induction charging unit 16 is formed by a secondary induction charging unit. Induction charging unit 16 is provided for wireless energy transmission for a charging process of cell unit 14. Induction charging unit 16 has a charging coil 36 and a core unit 38. Charging coil 36 is developed to be annular. Charging coil 36 is made up of a plurality of electrical conductors, which extend in the circumferential direction. The electrical conductors are wound in the circumferential direction about a winding axis 50. Core unit 38 is developed in the form of plates, and is made up of a magnetic material. Induction charging unit 16 is situated between cell unit 14 and a housing wall 40 of housing unit 32. Starting from housing wall 40 in the direction of cell unit 14, there follows first charging coil 36 of induction charging unit 16, core unit 38 of induction charging unit 16, a screening unit 42 and an electronics unit 44. Screening unit 42 is provided to protect electronics unit 44 from interference effects of charging coil 36, and vice versa.

Electronics unit 44 has charging electronic system 46. Furthermore, electronics unit 44 has a circuit board, not further visible, on which the charging electronic system 46 is situated. Charging electronic system 46 is connected to cell unit 14 via a line. Furthermore, charging electronic system 46 is connected to charging coil 36 via a line (FIG. 2).

Handheld tool battery device 10 is set up onto a charging area 52 of charging device 18. Charging area 52 forms a part of a housing unit 54 of charging device 18. In a provided stand, charging area 52 extends parallel to a sub-surface, and faces away from the sub-surface. Charging area 52 is provided to accommodate handheld tool battery device 10 for a charging process.

Moreover, charging device 18 has an induction charging unit 56 for transmitting energy. Induction charging unit 56 is formed by a primary induction charging unit. Induction charging unit 56 is provided for the wireless energy transmission from charging device 18 to handheld tool battery device 10. Induction charging unit 56 is provided to convert electrical energy to a magnetic field which is able to be reconverted to electrical energy by induction charging unit 16. Induction charging unit 56 has a charging coil 58, a core unit 60 and an electronics unit 62. Charging coil 58 is developed to be annular. Core unit 60 is developed in the form of plates, and is made up of a magnetic material. Induction charging unit 56 is totally situated in housing unit 54. Starting from charging area 52 of housing unit 54 in the direction of the center of charging device 18, there follows first charging coil 58 of induction charging unit 56, core unit 60 of induction charging unit 56, a screening unit 64 and an electronics unit 62. Screening unit 64 is provided to protect electronics unit 62 from interference effects of charging coil 58, and vice versa. Electronics unit 62 is connected to the energy supply by a cable 48 that is not further visible.

In addition, internal handheld tool battery device 10 has a communication unit 12. Communication unit 12 is formed by an NFC interface. Communication unit 12 forms a part of electronics unit 44. Communication unit 12 is also situated on the circuit board, that is not further visible, of electronics unit 44. Communication unit 12 is provided to transmit design-specific parameters to a charging device 18 during a charging process. For this purpose, charging device 18 also has a communication unit 66. Communication unit 66 of charging device 18 is also formed by an NFC interface. A transmission of design-specific parameters takes place automatically during an operation of charging device 18 when handheld tool battery device 10 approaches charging device 18. Communication units 12, 66 have a transmission distance which approximately corresponds to the transmission distance of induction charging units 16, 56. Because of the short transmission distance of NFC interfaces, it may be ensured that when there are two mutually registering units, they are charging device 18 and handheld tool battery device 10 that is to be charged, and not an handheld tool battery device 10 standing on the side. In principle it would also be conceivable that, via communication units 12, 66 additionally also the beginning of a charging process is being controlled. With the approach of handheld tool battery device 10 to charging device 18, in this context, a charging process is able to be begun automatically as soon as handheld tool battery device 10 is located at a sufficiently low distance.

Communication unit 12 is provided to transmit a battery quality factor to charging device 18 during a charging process. The battery quality factor describes a quality condition of handheld tool battery device 10.

Handheld tool battery device 10 has a memory unit 20, which is provided for the nonvolatile storage the design-specific parameters. The design-specific parameters are permanently filed on memory unit 20. Memory unit 20 is formed of a nonvolatile memory. Memory unit 20 forms a part of electronics unit 44, and is situated on the circuit board, that is not further visible, of electronics unit 44. Electronics unit 20 is connected to communication unit 12, that is not further visible.

Communication unit 12 of handheld tool battery device 10 is provided additionally to transmit characteristics variables of a maximum current of cell unit 14 to charging device 18, during a charging process. During a charging process, a maximum current of cell unit 14 is continuously or intermittently registered, and is transmitted via communication unit 12 to charging device 18. Moreover, communication unit 12 of handheld tool battery device 10 is provided additionally to transmit characteristics variables of a temperature of cell unit 14 to charging device 18, during a charging process. During a charging process, a current temperature of cell unit 14 is continuously or intermittently registered, and is transmitted via communication unit 12 to charging device 18. Moreover, communication unit 12 of handheld tool battery device 10 is provided additionally to transmit characteristics variables of a voltage of cell unit 14 to charging device 18, during a charging process. During a charging process, a current voltage of cell unit 14 is continuously or intermittently registered, and is transmitted via communication unit 12 to charging device 18.

The characteristics variables of handheld tool battery device 10, as well as the design-specific parameters of handheld tool battery device 10 are utilized by charging device 18 to adjust a charging process optimally to handheld tool battery device 10.

Handheld tool battery device 10 also has a registration unit 22 for registering characteristics variables of a maximum current, a temperature and a voltage of cell unit 14. Registration unit 22 has three sensor units 24, 26, 28. Registration unit 22 also has an arithmetic unit 68. Arithmetic unit 68 is situated on the circuit board of electronics unit 44, and is provided to control sensor units 24, 26, 28 and to process sensed characteristics variables. Arithmetic unit 68 of registration unit 22 is connected to communication unit 12, and is provided to transmit processed characteristics variables of a maximum current, a temperature and a voltage of cell unit 14 to charging device 18. Sensor unit 24 is formed of an ammeter and is provided to register characteristics variables of a maximum current of cell unit 14. Sensor unit 24 is integrated into charging electronic system 46 and is connected to arithmetic unit 68 in a manner not further visible. Sensor unit 26 is formed of a voltmeter and is provided to register characteristics variables of a current voltage of cell unit 14. Sensor unit 26 is integrated into charging electronic system 46 and is connected to arithmetic unit 68 in a manner not further visible. Sensor unit 28 is formed of a thermometer and is provided to register characteristics variables of a current temperature of cell unit 14. Sensor unit 28 is situated in cell unit 14 between cell elements 34.

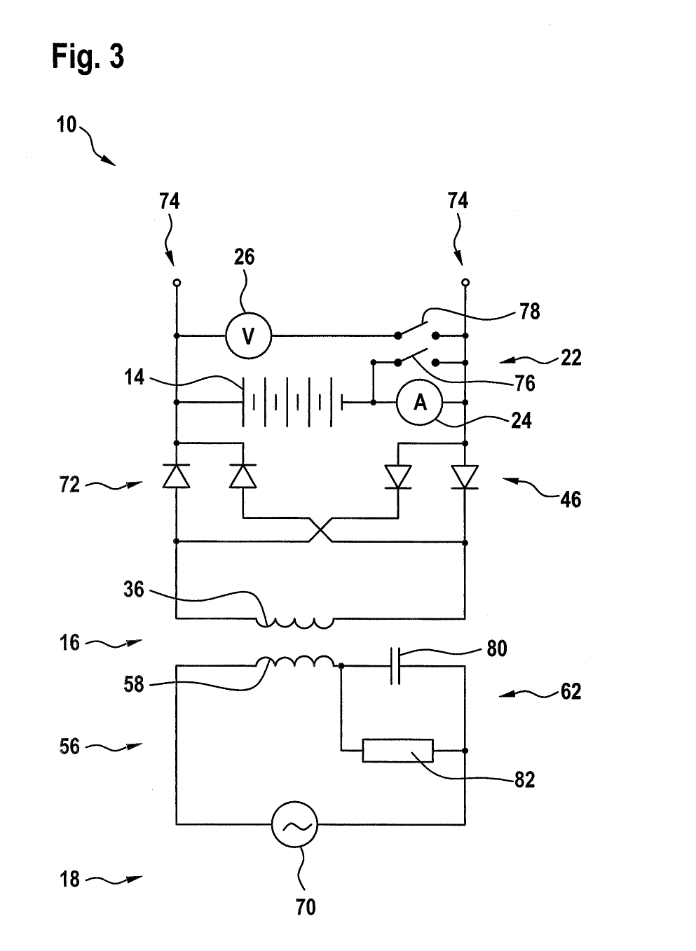

FIG. 3 shows a simplified circuit diagram of handheld tool battery device 10 according to the present invention and charging device 18 according to the present invention in a charging operation. The circuit diagram of handheld tool battery device 10 has, in this context, charging coil 36, charging electronic system 46 and cell unit 14. The circuit diagram of charging device 18 has induction charging unit 56, having charging coil 58 and having electronics unit 62 and an alternating voltage source 70. Charging electronic system 46 of handheld tool battery device 10 has a rectifier 72. Rectifier 72 is formed by a bridge rectifier. Rectifier 72 is connected directly to charging coil 36 and brings into line a voltage incoming at charging coil 36. An output side of rectifier 72 is connected to cell unit 14. Rectifier 72 is connected to cell unit 14 in such a way that charging cell unit 14 via rectifier 72 is possible, but discharging is not. Sensor unit 26 is connected in parallel to cell unit 14. Terminals 74 for a handheld machine tool, that is not further visible, are also connected in parallel to cell unit 14. Furthermore, a switch 76 and sensor unit 24 are connected in series to cell unit 14, switch 76 and sensor unit 24 being connected in parallel to each other. An additional switch 78 is connected in series to sensor unit 26. Sensor units 24, 26 may each be excluded from the circuit via switches 76, 78. Switches 76, 78 are automatically closed and opened by registration unit 22 during a registration. Thereby a mutual interference of sensor units 24, 26 may be excluded.

Charging coil 58 of charging device 18 is situated opposite charging coil 36 of handheld tool battery device 10, in a contactless manner. Charging coil 58 is connected in series to alternating voltage source 70. A capacitor 80 and a resistor 82 are connected in series to charging coil 58 and alternating voltage source 70, capacitor 80 and resistor 82 being connected in parallel to each other. Alternating voltage source 70 is formed indirectly from cable 48.

Handheld tool battery device 10 and charging device 18 form a system 30.

What is claimed is:

1. A handheld tool battery device, comprising:
a communication unit;
at least one cell unit for storing energy; and
at least one induction charging unit configured to provide at least one of charging and discharging of the at least one cell unit;
wherein the communication unit transmits design-specific parameters to an external charging device during a charging process.

2. The handheld tool battery device as recited in claim 1, wherein the communication unit transmits a battery quality factor to the external charging device during a charging process.

3. The handheld tool battery device as recited in claim 2, further comprising:
a memory unit providing nonvolatile storage of the design-specific parameters.

4. The handheld tool battery device as recited in claim 2, wherein the communication unit additionally transmits to the charging device at least one characteristics variable of a maximum current of the cell unit during a charging process.

5. The handheld tool battery device as recited in claim 2, wherein the communication unit additionally transmits to the charging device at least one characteristics variable of a temperature of the cell unit during a charging process.

6. The handheld tool battery device as recited in claim 2, wherein the communication unit additionally transmits to the charging device at least one characteristics variable of a voltage of the cell unit during a charging process.

7. The handheld tool battery device as recited in claim 4, further comprising:
a registering unit for registering the at least one characteristics variable of the maximum current of the cell unit, wherein the registering unit has at least one sensor unit.

8. A system comprising:
a charging device; and
a handheld tool battery device including:
a communication unit;
at least one cell unit for storing energy; and
at least one induction charging unit configured to provide at least one of charging and discharging of the at least one cell unit;
wherein the communication unit transmits design-specific parameters to the charging device during a charging process, the communication unit transmitting a battery quality factor to the charging device during a charging process.
